(19) United States
(12) Patent Application Publication
(10) Pub. No.: US 2026/0355955 A1
(43) Pub. Date: Nov. 12, 2026

(54) METHOD FOR CONTROLLING A TECHNICAL SYSTEM

(71) Applicant: Robert Bosch GmbH, Stuttgart (DE)

(72) Inventors: Harisankar Babu, Leonberg (DE); Philipp Christian Schillinger, Renningen (DE)

(21) Appl. No.: 19/653,356

(22) Filed: Apr. 21, 2026

(30) Foreign Application Priority Data
May 8, 2025 (EP) 25 17 5170.7

(51) Int. Cl. B25J 9/16

(52) U.S. Cl. CPC B25J 9/1661; B25J 9/161; B25J 9/163; B25J 9/1658

(57) ABSTRACT

A method for controlling a technical system. The method includes receiving a textual domain description describing actions that can be performed by the technical system and that change state properties of the technical system, generating a domain model according to the domain description using a domain model generator, receiving a textual initial state description describing an initial state of the technical system, generating an initial state model according to the initial state description using an initial state model generator, receiving a textual target state description describing a target state of the technical system, generating a target state model according to the target state description using a target state model generator, creating a plan using a symbolic planner by supplying the domain model, the initial state model and the target state model to a symbolic planner, and controlling the technical system according to the created plan.

The present disclosure relates to a method for controlling a technical system.

Controlling technical systems typically requires planning a sequence of actions. Conventional uses for planning in complex environments in which many different control situations may occur typically require extensive manual interventions by human users, which limits their scalability and accessibility.

Symbolic planners, for example, require domain models created by experts, which would have to be manually updated whenever the environment changes, making them unsuitable for dynamic, real-world applications. Although large language models (LLMs) have been able to generate structured outputs from natural language, they are prone to errors and are inconsistent.

Therefore, planning approaches are desirable that enable planning that is as autonomous as possible (with no or little intervention by human experts) and that also enable reliable planning.

According to various embodiments, a method for controlling a technical system is provided, comprising:
receiving a textual domain description describing actions that can be performed by the technical system and that change state properties of the technical system (e.g., whether a container is on another container)
generating a domain model according to the domain description by means of a domain model generator (i.e., the domain model specifies properties and possible actions as described in the domain description)
receiving a textual initial state description describing an initial state of the technical system
generating an initial state model according to the initial state description by means of an initial state model generator
receiving a textual target state description describing a target state of the technical system
generating a target state model according to the target state description by means of a target state model generator, wherein the domain model generator, the initial state model generator and the target state model generator are implemented by means of at least one generative language model (e.g., in each case by means of a particular generative language model, e.g., by means of at least one LLM) that processes the domain description, the initial state description and the target state description, respectively, and
wherein the domain model generator, the initial state model generator and the target state model generator exchange feedback regarding the domain model, the initial state model and/or the target state model during the generation of the domain model, the initial state model and/or the target state model, and adapt the domain model, the initial state model and the target state model, respectively, until the domain model, the initial state model and the target state model are consistent and/or complete (i.e., together yield a consistent and/or complete planning problem model)
creating a (control) plan by means of a symbolic planner by supplying the domain model, the initial state model and the target state model to a symbolic planner; and
controlling the technical system according to the created plan.

In contrast to conventional planning approaches or planning systems that required expert intervention or unreliable reasoning based on an LLM, making them inefficient for dynamic environments, according to the method described above, planning becomes a modular, adaptable process in which one or more LLMs help structure problems, while a symbolic planner ensures the correctness of the plan. A scalable, automated and accessible solution is thus enabled. This enables reliable control in complex environments that comprise a plurality of objects, scenes and tasks. According to various embodiments, this is achieved by cooperation among a plurality of agents, wherein the generative flexibility of large language models (LLMs) is combined with the structured reasoning capabilities of symbolic planners. The method is modular, scalable and adaptable to a plurality of planning problems, wherein it is particularly suitable for planning problems that are both complex and unstructured.

The method described above thus provides a general and scalable approach for planning for controlling technical systems. By combining at least one generative language model (e.g., one or more LLMs) with symbolic planning in a modular multi-agent framework, automatic adaptation to changing environments, improved consistency and a reduced dependence on expert interventions are ensured, as a result of which the planning approach is well suited for real-world applications such as robotics, industrial automation and autonomous systems.

A symbolic planner is a component in the cognitive architecture of autonomous robot devices that uses symbolic representations and logical reasoning to plan tasks. The symbolic planner creates (high-level) plans based on a symbolic representation of the environment and the goals of the robot device. These plans comprise a sequence of actions that are performed taking into account the current states and the desired target states (by a low-level control device). One example of this is a planner based on PDDL (Planning Domain Definition Language).

Various exemplary embodiments are specified below.

Exemplary embodiment 1 is a method for controlling a technical system, as described above.

Exemplary embodiment 2 is a method according to exemplary embodiment 1, wherein the initial state model generator checks whether state properties that the initial state description specifies are contained in the domain model and, in response to it determining that one or more state properties that the initial state description specifies are not contained in the domain model, prompts the domain model generator to supplement the domain model with the one or more state properties.

This is one example of how consistency and/or completeness of the planning problem model is established.

Exemplary embodiment 3 is a method according to exemplary embodiment 1 or 2, wherein the target state model generator checks whether state properties that the target state description specifies are contained in the domain model and, in response to it determining that one or more state properties that the target state description specifies are not contained in the domain model, prompts the domain model generator to supplement the domain model with the one or more state properties.

This is a further example of how consistency and/or completeness of the planning problem model is established.

Exemplary embodiment 4 is a method according to one of exemplary embodiments 1 to 3, wherein the target state model generator checks whether actions that make it possible to proceed from the initial state to the target state are contained in the domain model and, in response to it determining that one or more actions that make it possible to proceed from the initial state to the target state are not contained in the domain model, prompts the domain model generator to supplement the domain model with the one or more actions.

This is a further example of how consistency and/or completeness of the planning problem model is established.

Exemplary embodiment 5 is a method according to one of exemplary embodiments 1 to 4, wherein the target state model generator checks whether state properties that the target state description specifies are contained in the initial state model and, in response to it determining that one or more state properties that the target state description specifies are not contained in the initial state model, prompts the initial state model generator to supplement the initial state model with the one or more state properties.

This is a further example of how consistency and/or completeness of the planning problem model is established.

Exemplary embodiment 6 is a method according to one of exemplary embodiments 1 to 5, wherein the domain model contains variables, and each variable can have a plurality of values and describes a state property of the technical system.

Thus, the domain model can be processed by a symbolic planner.

Exemplary embodiment 7 is a method according to exemplary embodiment 6, wherein the initial state model generator generates the initial state model in such a way that it establishes the values of at least a portion of the variables according to the initial state description.

Thus, the initial state is clearly defined for the symbolic planner and follows the particular textual description.

Exemplary embodiment 8 is a method according to exemplary embodiment 6 or 7, wherein the target state model generator generates the target state model in such a way that it establishes the values of at least a portion of the variables according to the target state description.

Thus, the target state is clearly defined for the symbolic planner and follows the particular textual description.

Exemplary embodiment 9 is a method according to one of exemplary embodiments 1 to 8, wherein the domain description, the initial state description and the target state description are supplied to the at least one generative language model with the prompt to create a planning problem model or components of a planning problem model for the symbolic planner.

Figuratively speaking, the one or more generative language model(s) are thus used as an interface between the source of textual descriptions (i.e., e.g., a human user, documentation, an operating manual, etc.) and a symbolic planner. This increases scalability and adaptability in comparison with the sole use of a symbolic planner.

Exemplary embodiment 10 is a control device configured to carry out a method according to one of exemplary embodiments 1 to 9.

Exemplary embodiment 11 is a computer program having commands that, when executed by a processor, cause the processor to carry out a method according to one of exemplary embodiments 1 to 9.

Exemplary embodiment 12 is a computer-readable medium that stores commands that, when executed by a processor, cause the processor to carry out a method according to one of exemplary embodiments 1 to 9.

In the drawings, similar reference signs generally refer to the same parts throughout the various views. The drawings are not necessarily true to scale, with emphasis instead generally being placed on the representation of the principles of the invention. In the following description, various aspects are described with reference to the following drawings.

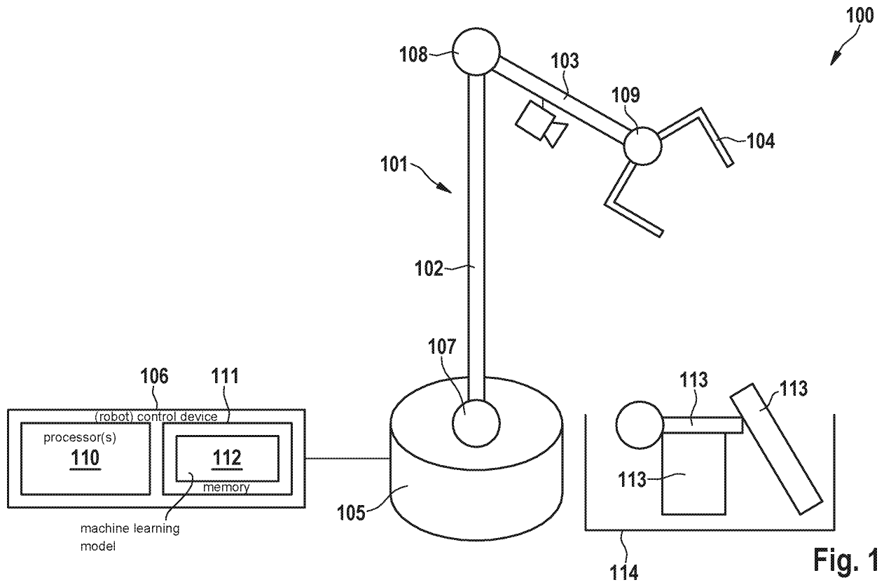

FIG. 1 shows a robot as an example of a technical system to be controlled.

FIG. 2 illustrates an example in which a planning problem model has to be adapted.

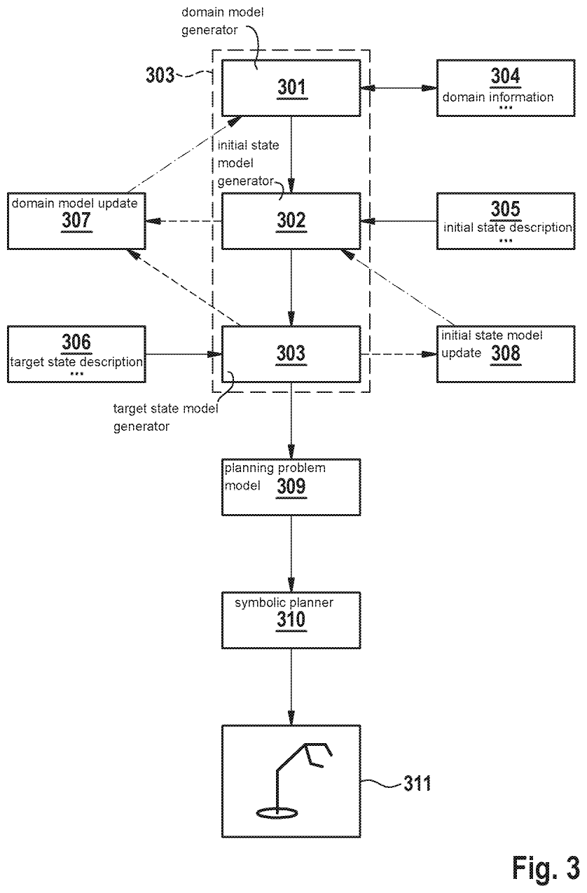

FIG. 3 illustrates a planning system according to an embodiment having a multi-agent planning framework architecture.

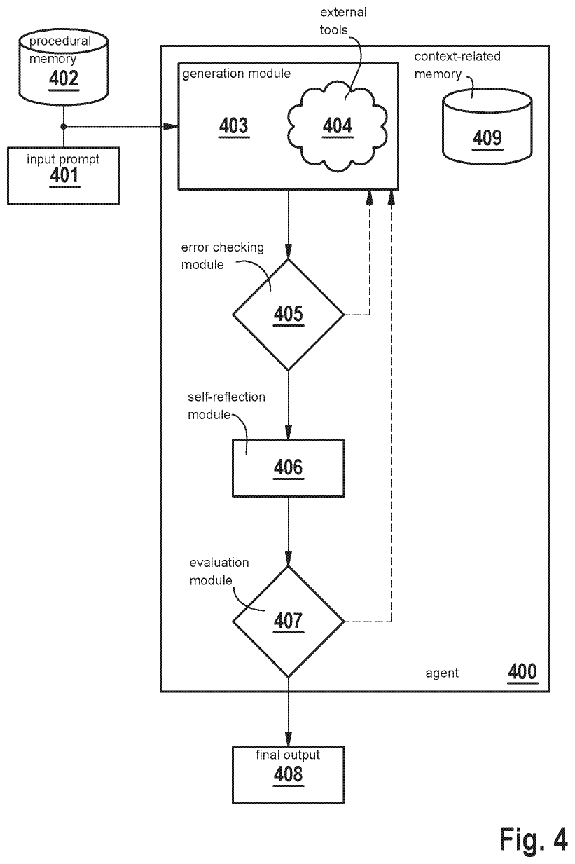

FIG. 4 shows an example of the architecture of an agent.

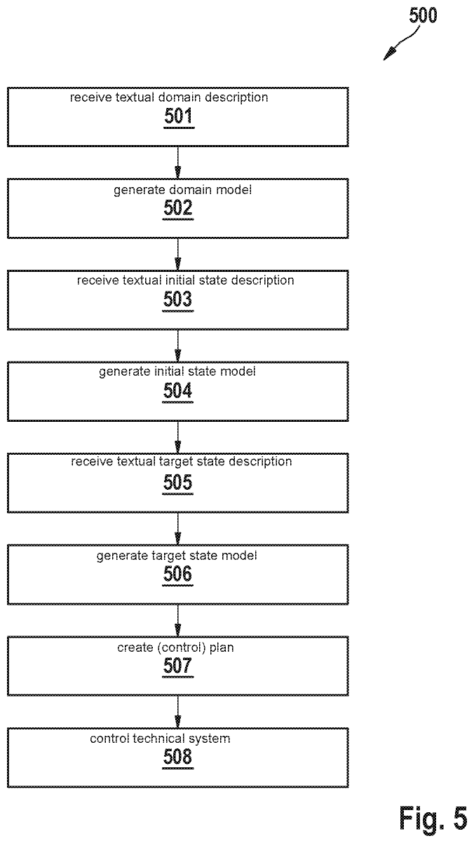

FIG. 5 shows a flowchart representing a method for controlling a technical system according to an embodiment.

The following detailed description relates to the accompanying drawings, which show, by way of explanation, specific details and aspects of this disclosure in which the invention can be carried out. Other aspects may be used, and structural, logical, and electrical changes may be performed without departing from the scope of protection of the invention. The various aspects of this disclosure are not necessarily mutually exclusive, since some aspects of this disclosure may be combined with one or more other aspects of this disclosure to form new aspects.

Various examples are described in more detail below.

FIG. 1 shows a robot 100 as an example of a technical system to be controlled.

The robot 100 comprises a robot arm 101, e.g., an industrial robot arm for handling or mounting a workpiece or one or more other objects 113. Obstacles 114, such as a container in which the objects 113 are located, or human users, which the robot arm 101 should not hit, may also be present in the control situation. The robot arm 101 comprises manipulators 102, 103, 104 and a base (or support) 105, which supports the manipulators 102, 103, 104. The term “manipulator” refers to the movable elements of the robot arm 101, the actuation of which enables a physical interaction with the environment, e.g., in order to perform a task. For control, the robot 100 comprises a (robot) control device 106, which is configured to carry out the interaction with the environment according to a control program. The last (farthest from the support 105) element 104 of the manipulators 102, 103, 104 is also referred to as an end effector 104 and comprises a gripping tool (which can also be a suction gripper).

The other manipulators 102, 103 (closer to the support 105) can form a positioning device, so that, together with the end effector 104, the robot arm 101 with the end effector 104 at its end is produced. The robot arm 101 is a mechanical arm that can fulfill functions similar to those of a human arm.

The robot arm 101 can comprise joint elements 107, 108, 109, which connect the manipulators 102, 103, 104 to one another and to the support 105. A joint element 107, 108, 109 can comprise one or more joints, each of which can enable the associated manipulators to perform a rotational movement (i.e., a rotary movement) and/or a translational movement (i.e., a displacement) relative to one another. The movement of the manipulators 102, 103, 104 can be initiated with the aid of actuators that are controlled by the control device 106.

The term “actuator” can be understood as a component that is suitable for acting on a mechanism or process when it is driven. The actuator can convert instructions of the control device 106 into mechanical movements. The actuator, e.g., an electromechanical transducer, can be configured to convert electrical energy into mechanical energy in response to control.

The term “control device” can be understood as any type of logic-implementing unit that can comprise, e.g., a circuit and/or a processor that is capable of executing software, firmware or a combination thereof stored in a storage medium and that can issue commands, e.g., to an actuator in the present example. The control device can be configured, e.g., by program code (e.g., software) to control the operation of a system, in the present example a robot.

In the present example, the control device 106 comprises one or more processors 110 and a memory 111, in which code and data are stored, on the basis of which the processor 110 controls the robot arm 101. According to various embodiments, the control device 106 controls the robot arm 101 on the basis of a machine learning model (e.g., including one or more neural networks) 112, which is stored in the memory 111.

When a technical system is controlled to carry out a task, actions are typically planned, such as gripping, moving, placing, etc. in the case of a robot arm, and these actions are then performed (which requires the control of the exact movement sequences, i.e., for example, a robot has to have certain capabilities such as safely gripping objects, etc).

For planning in uncertain, dynamic and complex environments, such as in robotics, as in the example of FIG. 1, but also in autonomous driving or industrial automation, which contain a plurality of objects and possible control situations and in which various tasks are to be carried out, referred to below as open-world environments, one typical approach is to use classical symbolic planners or standalone large generative language models (typically large language models (LLMs)) of both for planning.

Symbolic planners, such as PDDL-based planning frameworks, are excellent at creating optimal plans, but require the manual creation of domain models by experts, which is often associated with considerable effort (since human intervention is required to establish objects, predicates and action definitions).

In addition, these planners assume deterministic execution of the particular task and complete knowledge of the environment, which limits their applicability in real, unpredictable scenarios. Any change in the initial state or the goal requires manual updates to the task specification, so that spontaneous adaptation to changes is not possible. This makes them inefficient in environments that require frequent reconfiguration.

For example, if a robot is to set a table, a PDDL-based planner could generate an optimal order for placing the dishes. However, if the situation changes (e.g., the tables are moved to other locations), a human user has to manually change the initial states or the goal in the task specification. If the capabilities of the robot develop further, for example by acquiring a new capability for stacking plates, the domain specification also has to be manually updated in order to introduce a corresponding new action (according to the new capability).

Such manual intervention scales poorly in dynamic environments in which frequent state changes occur, which limits the effectiveness of symbolic planners in real-world applications.

On the other hand, LLMs have proven promising in bridging natural language understanding and symbolic reasoning. Frameworks such as LLM+P and NL2Plan have demonstrated the ability of LLMs to translate natural-language inputs into structured representations (e.g., domain models and plans) using multiple formats such as PDDL or Python code.

However, these approaches have difficulty maintaining consistency, tracking state changes and handling iterative corrections. They lack essential components such as feedback-driven refinement and persistent memory, which are crucial for adapting to evolving task requirements and maintaining consistency throughout the entire planning process.

For example, an LLM-based planner could generate the steps “pick up plate and place on table,” but if a new requirement regarding the plate color is added during the task (e.g., if the user expressly wants to select a “red plate”) it has difficulty taking this new requirement into account without explicitly resetting its planning process.

Overall, existing approaches for planning are hampered by limited modularity, a lack of robust error correction mechanisms and poor adaptability to changing environments. These limitations make controls for technical systems vulnerable and prevent effective scaling in order to meet the requirements of high-risk environments that require continuous adaptation, such as in robotics, medical care and automation.

In order to enable planning that is as autonomous as possible (with no or little intervention by human experts) and that is also reliable, according to various embodiments, a feedback-controlled multi-agent approach having a modular and structured architecture is provided, which combines one or more LLMs with symbolic reasoning (i.e., a symbolic planner).

Instead of relying on human experts to manually update planning models, or expecting LLMs to create complete plans, according to the provided approach, specialized agents (i.e., planning modules, thus software agents, e.g., in the form of or supported by one or more LLMs) are used to autonomously generate, validate and refine planning components.

Each of these agents focuses on a specific part of the task description, such as the generation of the domain model, the establishment of the initial conditions or the adaptation of the goals, while feedback loops between the agents ensure the adaptability and correctness of the task description. A symbolic planner then performs the planning on the basis of the task description supplied by the agents.

This reduces the manual workload, improves scalability and makes structured planning accessible to non-experts by allowing users (through the use of LLMs) to interact in natural language with the particular planning system (which uses the provided planning approach), while reliability is simultaneously ensured by symbolic reasoning (as carried out by a symbolic planner), since the actual planning is carried out by a symbolic planner.

The modular architecture enables seamless adaptation to new domains or integration into other planning systems with minimal reconfiguration. As a result, the planning framework can be easily expanded to various applications, including self-driving cars, drone deliveries and industrial robotics, without requiring major changes.

The planning system uses feedback loops between the agents in order to ensure that all components of the planning problem remain contextually aligned with one another. As a result, errors during plan creation and execution are minimized while iterative improvements are simultaneously enabled, i.e., the agents communicate and iteratively refine their results through feedback loops, as a result of which consistency and adaptability to evolving scenarios or user constraints are ensured.

If, for example, in a warehouse automation system, an agent responsible for inventory tracking detects a missing item, it can trigger a request to a human user and adapt the planning problem on the basis of the response (which does not necessarily have to be given by an expert in planning). This ensures that the planning process matches the current state of the warehouse, as a result of which disruptions are minimized and efficiency is maintained.

In contrast to static symbolic planners, which require manual updates for new constraints or evolving goals, the planning system thus automatically adapts to new or uncertain task requirements. As a result, it is extremely effective in environments in which real-time adaptability is critical. In autonomous parking, a self-driving car that uses such a planning system can adapt to unforeseen constraints during the parking process. For example, if the car initially plans to park at a certain location but detects an obstacle (e.g., an incorrectly parked vehicle or a pedestrian crossing the path), the planning system can refine its parking strategy by adapting its maneuvers or selecting a suitable space nearby, without external intervention being required.

This adaptability ensures smoother parking in dynamic environments in which conditions can change unpredictably.

FIG. 2 illustrates an example in which a planning problem model has to be adapted.

In a first control situation 201, three containers (denoted b1, b2, b3) are present in an environment, e.g., of the robot arm 101. In the initial state 202, b2 is located on b1, and a user 203 formulates (in natural language) the task 204 that b2 is to be stacked on b3, i.e., a target state 205 is to be reached, in which b2 is on b3.

A planner 206 creates a plan 207 for this goal and triggers a control that follows this plan.

In a second control situation 208, there are again three containers (denoted b1, b2, b3), wherein, in this example, b3 is stacked on b1. In addition, the containers differ visually (i.e., in container appearance, e.g., in color), shown here by diagonal hatching, cross hatching and horizontal hatching, and in size.

The user 203 now formulates (in natural language) the task 209 that a tower is to be formed from the three containers, with the largest container at the very bottom, the cross-hatched container in the middle and the horizontally hatched container at the very top.

If a domain model is assumed that was sufficient to describe the first control situation 201, then, for example, the predicates “container size” and “container appearance” are not present therein; i.e., the domain model has to be expanded by these predicates, and values have to be assigned to them in the initial state and in the final state.

FIG. 3 illustrates a planning system 300 according to an embodiment (e.g., implemented by the control device 106) having a multi-agent planning framework architecture.

In the exemplary embodiment of FIG. 3, three specialized agents—one domain model generator 301, one initial state model generator 302 and one target state model generator 303—cooperate in the planning system 300 in order to iteratively create a coherent and structured planning problem model 309 (in a format suitable for a symbolic planner 310, e.g., JSON, PDDL or as Python code). Each agent 301, 302, 303 is responsible for a specific aspect of the planning task:
The domain model generator 301 formulates the domain model (i.e., the model for the environment (and thus for possible control situations)) and possible actions that the technical system to be controlled (e.g., the robot arm 101) can carry out, on the basis of domain information 304 received by the planning system 300 (e.g., at least partially in natural language).
The modeling of the domain can, for example, comprise the following: identifying (suitable) predicates for representing states and properties of the environment (e.g., of objects) and transitions between states in the environment. Defining applicable actions and their prerequisites and effects. Identifying objects and their properties. Specifying constraints.
For the first control situation 201, the domain information 304 contains, for example, a domain description (shortened) such as
“The domain assumes a world in which containers can be stacked and unstacked with the aid of a robot arm, which can pick up containers and place them on the ground or on other containers.
The actions comprise:
   picking up: picking up a container from the ground preconditions:
      container is free (with no other container standing on it)
      container is standing on the ground
      arm is empty
   effects:
      arm now holds the container
      container is no longer free
      the container is no longer standing on the ground
      the arm is no longer empty
   putting down: placing a held container on the ground
   . . .
   stacking: placing a held container on another container
   . . .
   unstacking . . .
   . . .
The initial state model generator 302 specifies the initial state of the system to be controlled on the basis of an initial state description 305 received by the planning system 300 (e.g., at least partially in natural language). For the first control situation 201 from FIG. 1, the initial state description 305 is, for example:
There are three containers b3, b2 and b1. b2 is located on b1. The robot arm is empty”.
The target state model generator 303 specifies the desired result on the basis of a target state description 306 received by the planning system 300 (e.g., at least partially in natural language), which may be present in the form of the description of the task.
For the first control situation 201 from FIG. 1, the target state description 306 is, for example:
“The goal is to bring the containers into the following configuration: b2 is to stand on b3. b1 is to be located next to it.”

Each agent 301, 302, 303 supplies a part of the planning problem model 309 that is understandable or usable by the symbolic planner 310. For example, if each agent 301, 302, 303 supplies Python code, these parts could (in excerpts) look as follows (the various functions and variables being denoted here by English terms, as is customary in programming):

### Domain Description:

from up interface import add_action_effect, add_action_precondition, add_fluent_to_problem, create_action, create_fluent, create_problem, create_user_type, add_actions_to_problem
from unified_planning.shortcuts import BoolType
#Define problem
container_world_problem=create_problem(“container world”)
#Define necessary types
container=create_user_type(“container”) #containers that can be manipulated
#Define fluents
clear=create_fluent (“clear”, BoolType( ), parameters={“b”: container}) #no container on it
on_ground=create_fluent (“on_ground”, BoolType( ), parameters={“b”: container}) #container on the ground
. . .
#Add fluents to the problem
add_fluent_to_problem(container_world_problem, clear)
add_fluent_to_problem(container_world_problem, on_ground)
#Define actions
#pickup: pick up container from ground
pickup=create_action (“pickup”, {“b”: container})
#Preconditions
add_action_precondition (pickup, clear(pickup.b)) #the container must be free
. . .
#Effects
add_action_effect(pickup, holding (pickup. b), True) #arm now holds the container
. . .
#Put down: place held container on the ground
putdown=create_action (“putdown”, {“b”: container})
#Preconditions
. . .
#Add actions to the problem
add_actions_to_problem(container_world_problem, [pickup, putdown, stack, unstack])

### Initial State:

from up_interface import add_objects_to_problem, create_object, set initial value
#Create container objects
b1=create_object(“b1”, container)
b2=create_object(“b2”, container)
b3=create_object(“b3”, container)
#Add objects to the problem
add_objects_to_problem(container_world_problem, [b1, b2, b3])
#Set initial values for fluents
#Container positions
set_initial_value(container_world_problem, on(b2, b1), True) #b2 on b1
. . .
#Free status
set_initial_value(container_world_problem, clear(b2), True) #b2 is free
. . .
#Arm status
set_initial_value(container_world_problem, arm_empty( ), True) #arm is empty
#Containers are not held
set_initial_value(container_world problem, holding (b1), False) #arm does not hold b1
. . .

The code for the target state may be analogous to the code for the initial state.

In PDDL, the planning problem model 309 could, for example, be as follows (wherein, again, each agent (301, 302, 303) has contributed a corresponding part):

```
(define (domain container_world-domain)
  (:requirements :strips :typing)
  (:types container)
  (:predicates (clear ?b - container) (on table ?b - container)
(holding ?b - container) (on ?b1 - container ?b2 - container)
(arm_empty) )
  (:action pickup
  :parameters (?b - container)
  :precondition (and (clear ?b) (on table ?b) (arm_empty) )
  :effect (and (holding ?b) (not (clear ?b) ) (not (on_table ?b) )
(not (arm_empty) ) ) )
  (:action putdown
  :parameters (?b - container)
  :precondition (and (holding ?b) )
  :effect (and (clear ?b) (arm_empty) (on_table ?b) (not (holding
?b) ) ) )
  (:action stack
  :parameters (?b1 - container ?b2 - container)
  :precondition (and (holding ?b1) (clear ?b2) )
  :effect (and (arm_empty) (clear ?b1) (on ?b1 ?b2) (not (clear
?b2) ) (not (holding ?b1) ) ) )
  (:action unstack
  :parameters (?b1 - container ?b2 - container)
  :precondition (and (on ?b1 ?b2) (arm_empty) (clear ?b1) )
  :effect (and (holding ?b1) (clear ?b2) (not (on ?b1 ?b2) ) (not
(clear ?b1) ) (not (arm_empty) ) ) )
)
(define (problem container_world-problem)
  (:domain container_world-domain)
  (:objects
  b1 b2 b3 - container
  )
  (:init (on b2 b1) (on_ground b3) (on_ground b1) (clear b2)
(arm_empty) )
  (:goal (and (on b2 b3) (on_ground b3) (on_ground b1) ) )
  )
```

The planning problem model 309 is supplied to the symbolic planner 310, which ascertains a plan having actions to be carried out and provides these to a (low-level) control unit 310, e.g., a controller, so that the control unit performs them and thus controls the technical system 311 according to the plan.

The inputs 304, 305, 306 to the planning system 300, which correspond to each aspect (domain, initial state and goal), are supplied (e.g., by an input interface or an input-data preprocessing module) to the particular agent 301, 302, 303. In addition, update request signals (shown in FIG. 3 as dashed and dash-dotted arrows) enable the agents to communicate changes or corrections to one another or request them from one another in order to ensure that changes in one component (e.g., a new constraint or updated information) trigger corresponding adaptations in the other components.

For example, the initial state model generator 302 and the target state model generator 303 can request a domain model update 307 from the domain model generator 301. This can occur, for example, as in the example mentioned in connection with FIG. 2, if, e.g., the target state model generator 303 determines that it cannot formulate the target state sufficiently (e.g., containers having a specific appearance at a specific position), since the domain model lacks a corresponding predicate (e.g., container appearance). Similarly, the target state model generator 303 could request an initial state model update 308 from the initial state model generator 302 if, for example, the initial state model does not describe a property that is described or has to be described in the target state model (and the initial state model and the target state model are thus not yet consistent).

The planning system 300 receives the inputs 304, 305, 306 in various formats, such as natural-language descriptions, structured data or sensor signals (e.g., images from cameras, LiDAR, radar and audio inputs), which provide information regarding the control situation and/or the initial state. It processes these inputs and converts them into structured representations (e.g., predicates, fluents, states, actions) that serve as a basis for planning.

Possible input types (and the models implemented accordingly therefor by the agents 301, 302, 303 and/or processing techniques (if applicable, connected upstream of the agents 301, 302, 303)) are:
Text-based inputs: written summaries and descriptions, e.g., in relation to the initial situation (i.e., current situation) or possible interaction schemes with related applications (e.g., application programming interfaces (APIs)). This type of data can be processed by language models (e.g., LLMs) or text embedding models. According to various embodiments, the input to each of the agents 301, 302, 303 is at least partially text-based.
Image-based inputs: digital images and video feeds are processed with the aid of computer vision or deep learning techniques (as the agents 301, 302, 303 can implement) in order to extract relevant spatial and semantic information.
Radar and LiDAR inputs: sensor data from LiDAR and radar can be encoded with the aid of deep learning models (e.g., 3D object recognition networks and scene representation models) in order to create structured representations of the environment. As a result, the planning system 300 can detect objects, estimate distances and recognize dynamic changes.
Audio inputs: audio signals, such as spoken commands or environmental cues, are converted into text, for example, by the planning system 300 with the aid of speech-to-text models, so that user commands can be interpreted by means of NLP (natural language processing) techniques, or information about the control situation can be derived (similarly to text-based inputs).

The planning is divided into planning subtasks, which can be coarse-grained or fine-grained depending on the complexity and requirements of the problem of the (control) task to be carried out (e.g., can in each case be carried out for larger or smaller partial (control) tasks of the (control) task to be carried out). Planning subtasks are:
generating a domain model (by the domain model generator 301)
specifying initial conditions (by the initial state model generator 302)
specifying goals (by the target state model generator 303)
resolving inconsistencies between planning components (e.g., by exchanging corresponding feedback (i.e., feedback messages, e.g., requests) between the agents 301, 302, 303).

As explained above, the planning subtasks of domain model generation, initial state specification and target state specification are assigned to the specialized agents 301, 302, 303. These agents work autonomously, but can communicate and thus cooperate via a common memory or alternative communication channels such as application programming interfaces (APIs), interrupts and message-passing interfaces. The agents 301, 302, 303 work together iteratively by refinement and feedback loops in which they criticize, update and coordinate their results (by means of feedback) (by communicating with one another, for example using the aforementioned communication options), until a consistent planning problem model 309 is created. This cooperation ensures coherence, consistency and adaptability across all components of the planning problem.

FIG. 4 shows an example of the architecture of an agent 400 (which can be used for one or more of the agents 301, 302, 303).

The agent 400 receives an input prompt 401, which it by means of a generation module 403 that is responsible for creating outputs (depending on the planning subtask), is implemented by means of an LLM, and can be supplemented by external tools 404 (optionally) in order to improve its generative capabilities.

Input information from the input prompt 401 and optional contents from a procedural memory 402 (for long-term collected experiences) flow into the generation process carried out by the generation module 403 and ensure that both immediate instructions and, if applicable, historical context are available. Once the generation module 403 an output (corresponding to the planning subtask to be carried out by the agent 400) was generated, the output optionally passes through an error-checking module 405, in which the agent 400 checks the correctness and consistency of the output. If errors are found, the error-checking module 405 sends signals for iterative improvement back to the generation module 403 via a feedback loop.

If applicable, after iterative improvement, the output is then optionally forwarded to a self-reflection module 406, where the output is further refined by internal evaluation and self-criticism. After the self-reflection, an evaluation module 407 optionally assesses whether the output reaches a predetermined quality threshold; otherwise, negative feedback is provided to the generation module 403. Only results that exceed or reach this threshold are output by the agent 400 as a final output 408.

During this process, a context memory continuously stores the most recent interactions and data in order to ensure that the agent remains coherent across a plurality of iterations. This serves effective cooperation between the agents, since they are thus able to respond coherently to external requests and maintain coordination between the components. The design with its integrated feedback loops and optional extension modules supports iterative refinement and dynamic learning, as a result of which the agent 400 becomes both robust and adaptable for complex planning tasks.

The agent can comprise a context-related memory 409, which ensures coordination between interactions (e.g., with other agents), feedback messages and tasks by storing task-related information and current interactions. It can store either the entire history or a subset of the last interactions (e.g., the last n interactions).

It ensures that agents maintain the coherence of their outputs and dynamically adapt to evolving inputs or constraints.

Based on the planning problem model 309, the symbolic planner 310 creates a sequential plan. Creating the plan comprises evaluating actions, states and transitions in order to ensure that the plan satisfies the defined constraints and goals.

The plan is can be represented in various formats that are suitable for execution or communication. Examples of this are natural-language instructions (for human operators) and machine-readable formats (for autonomous systems).

The planning system 300 can contain additional components in order to improve performance, although they are not absolutely necessary for the core functionality, such as.
The procedural memory 402: this records lessons from previous planning problems, including user feedback, corrections for recurring errors and strategies that have led to successful results. A component for procedural memory (i.e., for storing and retrieving procedures for completing tasks) enables lifelong learning by storing knowledge from the completion (specifically planning) of previous tasks and corrections that occurred therein. As a result, the planning system can improve over time by avoiding repeated errors and incorporating proven procedures. For example, a robot system that is used in a logistics center can learn from previous error corrections, and its efficiency can thus improve. In a scenario in which a robot retrieves eggs from a refrigerator, for example, the procedural memory allows the system to recognize that subsequently closing the refrigerator door is generally expected behavior, even if it is not expressly required to reach the goal.
The self-reflection/criticism mechanisms of the self-reflection module 406 or of the evaluation module 407: the planning system can implement a structured self-reflection process in order to iteratively refine the outputs of the agents 301, 302, 303 of the generation modules 403. After the generation of a response, an internal critic (e.g., an LLM) evaluates the response based on predefined criteria such as correctness, coherence and task alignment. If required, the output is updated based on the feedback from the critic, and the generation process is repeated until an acceptable quality threshold is reached. This iterative refinement improves accuracy, robustness and adaptability.

The planning system 300 can be configured differently depending on the complexity of the control task, and agents 301, 302, 303 can also be combined, e.g.:
Coarse configuration: in simpler scenarios, a small number of agents (e.g., three) work together in order to define the domain model, the initial state and the goals.
Fine configuration: in more complex scenarios, planning subtasks can be further subdivided.

The plurality of agents work together in order to ensure that the planning problem model is defined coherently and contextually aligned with the requirements. Various communication architectures can be used for communication between the agents for this cooperation, including tool-calling APIs, message-passing interfaces, exception-based signaling, structured output generation (e.g., JSON, XML), tagged text and keywords.

Various approaches can be supported as the symbolic planner 310, and the planning system 300 is thus adaptable to various applications. Possible symbolic planners are, e.g., PDDL-based planners, other heuristic planners and temporal planners.

In summary, according to various embodiments, a method is provided as shown in FIG. 5.

FIG. 5 shows a flowchart 500 representing a method for controlling a technical system according to an embodiment.

In 501, a textual domain description is received, which describes actions that can be performed by the technical system and that change state properties of the technical system (e.g., whether a container is on another container).

In 502, a domain model is generated according to the domain description by means of a domain model generator (i.e., the domain model specifies properties and possible actions as described in the domain description).

In 503, a textual initial state description is received, which describes an initial state of the technical system.

In 504, an initial state model is generated according to the initial state description by means of an initial state model generator.

In 505, a textual target state description, which describes a target state of the technical system, is received.

In 506, a target state model is generated according to the target state description by means of a target state model generator.

The domain model generator, the initial state model generator and the target state model generator are implemented by means of at least one generative language model (e.g., in each case by means of a particular generative language model) that processes the domain description, the initial state description and the target state description, respectively.

During generation of the models, the domain model generator, the initial state model generator and the target state model generator exchange feedback regarding the domain model, the initial state model and/or the target state model and adapt the domain model, the initial state model and the target state model, respectively, until the domain model, the initial state model and the target state model are consistent and/or complete (i.e., together yield a consistent and/or complete planning problem model).

In 507, a (control) plan is created by means of a symbolic planner by supplying the domain model, the initial state model and the target state model (e.g., combined into a planning problem model) to a symbolic planner.

In 508, the technical system is controlled according to the created plan.

It should be noted that the order of the steps in FIG. 5 is only one example, and other orders are also possible. For example, all descriptions can also be received first, and then the models can be generated simultaneously. It is also possible to switch back and forth between the steps, e.g., because feedback is provided by another step. For example, the domain model is adapted again after it was previously generated, if this becomes necessary.

The method of FIG. 5 can be carried out by one or more computers having one or more data processing units. The term “data processing unit” may be understood as any type of entity that allows for processing of data or signals. The data or signals can be processed, for example, according to at least one (i.e., one or more than one) specific function which is carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the particular functions described in more detail herein may also be understood as a data processing unit or logic circuit assembly. One or more of the method steps described in detail here can be carried out (e.g., implemented) by a data processing unit by one or more specific functions that are carried out by the data processing unit.

The method is therefore in particular computer-implemented according to various embodiments. It can be carried out automatically. The provided control method (or a control system or planning system that is designed according to such a control method, in particular planning approach) can be applied to planning problems (and thus to control problems) in various fields that may require dynamic, adaptable planning.

The control method according to FIG. 5 can work (in addition to the textual descriptions) with various data derived, e.g., from the following sensor signals:
digital image data, including video, radar, LiDAR, ultrasound, motion and thermal images
audio signals for voice-controlled task planning or cues with respect to the environment

The method according to FIG. 5 can be used in control systems or autonomous systems in order to create and refine plans in response to changing environmental conditions, user-specific constraints and user-specific goals and to extract structured task representations from unstructured inputs in natural language.

Examples of use cases include:
automated creation and execution of assembly sequences in manufacturing processes
scheduling for assistance robots in healthcare facilities or in personalized care.
generating sequential tasks to fulfill user requests.

According to various embodiments, the method according to FIG. 5 serves long-term task planning, in which an intelligent system has to generate a sequence of high-level actions in order to achieve a complex, multi-step goal. It focuses, for example, on goal-oriented planning rather than motion planning, and is therefore suitable for scenarios that require structured thinking about longer tasks, such as putting together meals in a kitchen, carrying out multi-step assembly operations in manufacturing or executing workflows having a long time horizon in healthcare. According to various embodiments, strengths of large language models (LLMs) and classical symbolic planners are combined. Traditional symbolic planners can create optimal task plans, but require manually created domain models and problem specifications. These planners assume static environments and deterministic execution, as a result of which they are unsuitable for dynamic tasks in the real world in which goals or initial conditions can change. LLMs, on the other hand, are distinguished by the processing of unstructured inputs in natural language and the generation of structured outputs, but have difficulty with domain-specific reasoning, adaptability and consistency. According to various embodiments, the method according to FIG. 5 integrates LLMs and symbolic planners into a unified multi-agent framework, in which each agent is specialized for specific tasks. The modularity of the tasks executed by the agents is extremely flexible and adaptable to the complexity of the planning problem. In one configuration, the framework can consist of a small number of agents, e.g., one agent for creating a domain model (if not already present) and another agent for defining the problem or task statement (i.e., a planning problem model) on the basis of the domain model. In more complex scenarios, a task can be divided into subtasks (for which, e.g., a particular planning problem model is then created). The planning problem model is processed by the symbolic planner, i.e., actions are planned, and the particular technical system is then controlled in such a way that these planned actions are performed.

According to various embodiments, a plurality of agents work together in order to ensure that the task problem (in particular the planning) planning problem is consistently defined and contextually aligned with the requirements. The agents communicate and iteratively refine their results through feedback loops, as a result of which consistency and adaptability to evolving scenarios or user constraints are ensured. This planning approach is particularly useful for fields that require structured, long-term decision-making instead of real-time motion planning, e.g.:
Household robotics: e.g., planning a complete cooking sequence (e.g., preparing a sandwich, setting a table, emptying a dishwasher).
Industrial automation: e.g., long-term task planning in manufacturing (e.g., assembling a plurality of components over time)
Healthcare support: e.g., carrying out multi-step patient care routines, such as medication dispensing and meal dispensing.
Autonomous service robots: e.g., hotel or restaurant assistants that plan sequential service tasks (e.g., preparation, dispensing and cleaning after a meal).
Autonomous driving: handling complex, multi-step decision-making during autonomous driving.
Autonomous flying: e.g., multi-step decision-making during delivery by drone (e.g., coordinating landing in densely populated urban areas).

According to various embodiments, the method of FIG. 5 uses basic principles of both natural language processing (NLP) and symbolic planning in order to overcome the limits of conventional planning approaches. Recent advances in NLP and large language models (LLMs) enable a deeper understanding of natural language and other text-based or image-based representations and can be viewed as a basis of the planning approach of FIG. 5.

LLMs provide the capability of semantic reasoning and natural language understanding. They use pre-trained transformer-based architectures in order to map unstructured inputs to structured outputs. The method of FIG. 5 builds on this capability by generating, by means of suitable prompts, LLM-generated outputs that are in accordance with symbolic representations of planning models such as PDDL, Python code or JSON.

These prompts guide the LLMs to generate modular and consistent planning components (of a planning model), which satisfy the syntactic and semantic requirements of symbolic planners and ensure both compatibility and accuracy.

The Unified Planning Framework provides a formalism for defining planning problems as sets of states, actions and transitions. According to various embodiments, the method of FIG. 5 bridges the gap between this formalism and unstructured descriptions in natural language by generating (e.g., dynamically) modular components of a planning problem model (domain model, initial state, target state). This modularity enables the symbolic planner that processes the planning problem model to operate effectively in open-world environments, and enables the dynamic adaptation of plans to new constraints, goals or environmental changes.

According to various embodiments, training data for planning algorithms can also be generated. This comprises, for example, developing synthetic scenarios for jointly training LLMs and symbolic planners and/or testing the adaptability and robustness of planning systems under various and challenging conditions.

The approach of FIG. 5 (ultimately) serves to generate a control signal for a robot device, in particular in environments with humans (or environments that are designed for humans or are “human-centered”) and robot devices that require adaptable behavior in changing contexts. The term “robot device” can be understood as referring to any technical system (in particular having a mechanical part, the movement of which is controlled) such as a computer-controlled machine, a vehicle, an automatic device, e.g., a household appliance, a power tool, a manufacturing machine, a personal assistant or an access control system.

1-12. (canceled)

13. A method for controlling a technical system, comprising the following steps:
receiving a textual domain description describing actions that can be performed by the technical system and that change state properties of the technical system;
generating a domain model according to the domain description using a domain model generator;
receiving a textual initial state description describing an initial state of the technical system;
generating an initial state model according to the initial state description using an initial state model generator;
receiving a textual target state description describing a target state of the technical system;
generating a target state model according to the target state description using a target state model generator;
wherein the domain model generator, the initial state model generator, and the target state model generator are implemented using at least one generative language model that processes the domain description, the initial state description, and the target state description, respectively;
wherein the domain model generator, the initial state model generator, and the target state model generator exchange feedback regarding at least one of the domain model, the initial state model, or the target state model, during at least one of the generation of the domain model, the generation of the initial state model, or the generation of the target state model, and adapt the domain model, the initial state model and the target state model, respectively, until the domain model, the initial state model and the target state model are consistent and/or complete;
creating a plan using a symbolic planner by supplying the domain model, the initial state model, and the target state model to the symbolic planner; and
controlling the technical system according to the created plan.

14. The method according to claim 13, wherein the initial state model generator checks whether state properties that the initial state description specifies are contained in the domain model and, in response to the initial state model generator determining that one or more state properties that the initial state description specifies are not contained in the domain model, prompts the domain model generator to supplement the domain model with the one or more state properties.

15. The method according to claim 13, wherein the target state model generator checks whether state properties that the target state description specifies are contained in the domain model and, in response to the target state model generator determining that one or more state properties that the target state description specifies are not contained in the domain model, prompts the domain model generator to supplement the domain model with the one or more state properties.

16. The method according to claim 13, wherein the target state model generator checks whether actions that make it possible to proceed from the initial state of the technical system to the target state of the technical system are contained in the domain model and, in response to the target state model generator determining that one or more actions that make it possible to proceed from the initial state of the technical system to the target state of the technical system are not contained in the domain model, prompts the domain model generator to supplement the domain model with the one or more actions.

17. The method according to claim 13, wherein the target state model generator checks whether state properties that the target state description specifies are contained in the initial state model and, in response to the target state model generator determining that one or more state properties that the target state description specifies are not contained in the initial state model, prompts the initial state model generator to supplement the initial state model with the one or more state properties.

18. The method according to claim 13, wherein the domain model contains variables, and each of the variables can have a plurality of values and describes a state property of the technical system.

19. The method according to claim 18, wherein the initial state model generator generates the initial state model in such a way that the initial state model establishes the values of at least a portion of the variables according to the initial state description.

20. The method according to claim 18, wherein the target state model generator generates the target state model in such a way that the target state model establishes the values of at least a portion of the variables according to the target state description.

21. The method according to claim 13, wherein the domain description, the initial state description, and the target state description are supplied to the at least one generative language model with a prompt to create a planning problem model or components of a planning problem model for the symbolic planner.

22. A control device configured to control a technical system, the control device configured to perform the following steps:
receiving a textual domain description describing actions that can be performed by the technical system and that change state properties of the technical system;
generating a domain model according to the domain description using a domain model generator;
receiving a textual initial state description describing an initial state of the technical system;
generating an initial state model according to the initial state description using an initial state model generator;
receiving a textual target state description describing a target state of the technical system;
generating a target state model according to the target state description using a target state model generator;
wherein the domain model generator, the initial state model generator, and the target state model generator are implemented using at least one generative language model that processes the domain description, the initial state description, and the target state description, respectively;
wherein the domain model generator, the initial state model generator, and the target state model generator exchange feedback regarding at least one of the domain model, the initial state model, or the target state model, during at least one of the generation of the domain model, the generation of the initial state model, or the generation of the target state model, and adapt the domain model, the initial state model and the target state model, respectively, until the domain model, the initial state model and the target state model are consistent and/or complete;
creating a plan using a symbolic planner by supplying the domain model, the initial state model, and the target state model to the symbolic planner; and
controlling the technical system according to the created plan.

23. A non-transitory computer-readable medium that stores commands for controlling a technical system, the commands, when executed by a processor, causing the processor to perform the following steps:
receiving a textual domain description describing actions that can be performed by the technical system and that change state properties of the technical system;
generating a domain model according to the domain description using a domain model generator;
receiving a textual initial state description describing an initial state of the technical system;
generating an initial state model according to the initial state description using an initial state model generator;
receiving a textual target state description describing a target state of the technical system;
generating a target state model according to the target state description using a target state model generator;
wherein the domain model generator, the initial state model generator, and the target state model generator are implemented using at least one generative language model that processes the domain description, the initial state description, and the target state description, respectively;
wherein the domain model generator, the initial state model generator, and the target state model generator exchange feedback regarding at least one of the domain model, the initial state model, or the target state model, during at least one of the generation of the domain model, the generation of the initial state model, or the generation of the target state model, and adapt the domain model, the initial state model and the target state model, respectively, until the domain model, the initial state model and the target state model are consistent and/or complete;
creating a plan using a symbolic planner by supplying the domain model, the initial state model, and the target state model to the symbolic planner; and
controlling the technical system according to the created plan.
